(19) United States
(12) Patent Application Publication
(10) Pub. No.: US 2017/0090365 A1
(43) Pub. Date: Mar. 30, 2017

(54) PRINT SHEET CREATION METHOD

(71) Applicant: CASIO COMPUTER CO., LTD., Tokyo (JP)

(72) Inventors: Fumio SHIMAZU, Tokyo (JP); Kazuhiro KAMEYAMA, Tokyo (JP); Shohei OGAWA, Tokyo (JP)

(73) Assignee: CASIO COMPUTER CO., LTD., Tokyo (JP)

(21) Appl. No.: 15/207,446

(22) Filed: Jul. 11, 2016

(30) Foreign Application Priority Data
Sep. 30, 2015 (JP) 2015-194842
Jun. 29, 2016 (JP) 2016-129062

(51) Int. Cl. B44C 1/17

(52) U.S. Cl. CPC G03G 15/2053

(57) ABSTRACT

A print sheet creation method, including a first transfer step of forming a laminated film by transferring a first toner layer including achromatic toner and a second toner layer including chromatic toner and formed on the first toner layer to a first transfer target medium, a second transfer step of transferring the formed laminated film to a second transfer target medium from the first transfer target medium such that the first toner layer is an uppermost layer, a first fixing step of fixing the laminated film transferred to the second transfer target medium to the second transfer target medium, and a third transfer step of transferring a third toner layer which includes achromatic toner and is thicker than the first toner layer to the laminated film fixed to the second transfer target medium and having the first toner layer as the uppermost layer.

### CROSS-REFERENCE TO RELATED APPLICATIONS

This application is based upon and claims the benefit of priority from the prior Japanese Patent Applications No. 2015-194842, filed Sep. 30, 2015 and No. 2016-129062, filed Jun. 29, 2016, the entire contents of which are incorporated herein by reference.

### BACKGROUND OF THE INVENTION

1. Field of the Invention

The present invention relates to a print sheet creation method.

2. Description of the Related Art

Conventionally, in an electrophotographic image forming apparatus, a photosensitive drum in a developing device is generally initialized by being equally charged, a latent image is formed by optical writing on the photosensitive drum, the latent image is changed (developed) into a toner image, and the toner image is directly or indirectly transferred to a print target medium and fixed thereto by a fixing device.

As a method for printing a desired image or a design such as a logo on a final transfer target medium such as a fabric product including a T-shirt, a sweat shirt, or work clothes, wood, or a metal plate in the above-described image forming apparatus, a technique is known in which a thermal transfer print sheet is created by an image to be thermally transferred to the final transfer target medium and an adhesive agent for bonding the image to the final transfer target medium (hereinafter referred to as binder toner) being laminated on a mediating sheet such as a release sheet.

For example, Japanese Patent Application Laid-Open (Kokai) Publication No. 2011-152662 proposes a technique of, when creating the above-described thermal transfer print sheet, overlaying a sheet on which an image to be thermally transferred to a final transfer target medium is formed and a sheet having a binder toner layer such that they oppose each other and applying heat and pressure thereto so as to laminate the image and an adhesive agent.

However, in the technique disclosed in Japanese Patent Application Laid-Open (Kokai) Publication No. 2011-152662, since the sheets are separate sheets, an image layer and an adhesive agent layer respectively having different compositions are opposed to each other in a cold state and heat and pressure are applied thereto. Accordingly, a bonding force between the image to be thermally transferred to the print target medium and binder toner is weak. Therefore, there is a problem in that, when the transfer target medium such as a T-shirt to which the image has been bonded is washed, the image is scrubbed and removed.

### SUMMARY OF THE INVENTION

An object of the present invention is to make a bonding force between an image to be thermally transferred to a final transfer target medium and an adhesive agent more reliable.

In accordance with one aspect of the present invention, there is provided a print sheet creation method, comprising: a first transfer step of forming a laminated film by transferring a first toner layer including achromatic toner and a second toner layer including chromatic toner and formed on the first toner layer to a first transfer target medium; a second transfer step of transferring the laminated film formed in the first transfer step to a second transfer target medium from the first transfer target medium such that the first toner layer is an uppermost layer; a first fixing step of fixing the laminated film transferred to the second transfer target medium in the second transfer step to the second transfer target medium; and a third transfer step of transferring a third toner layer which includes achromatic toner and is thicker than the first toner layer to the laminated film fixed to the second transfer target medium in the first fixing step and having the first toner layer as the uppermost layer.

In accordance with another aspect of the present invention, there is provided a print sheet creation method, comprising: a first step of forming, on a predetermined sheet, an image acquired by laminating a first achromatic toner layer and a chromatic toner layer such that the first achromatic toner layer is an uppermost layer, by using electrophotography; and a second step of forming a second achromatic toner layer on the sheet where the image has been formed in the first step such that the second achromatic toner layer covers the first achromatic toner layer and is thicker than the first achromatic toner layer, by using electrophotography.

In accordance with another aspect of the present invention, there is provided a print sheet creation method, comprising: a first step of forming an image covered with a protective layer on a predetermined sheet by using electrophotography; and a second step of forming, on the sheet where the image covered with the protective layer has been formed, an adhesive layer including toner of same type as toner constituting the protective layer such that the adhesive layer covers the protective layer and is thicker than the protective layer, by using electrophotography.

According to the present invention, a bonding force between an image to be thermally transferred to a final transfer target medium and an adhesive agent can be made more reliable.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a cross-sectional view showing the internal structure of an image forming apparatus 1;

FIG. 2 is a conceptual diagram showing a positional relationship among a density sensor 40, a temperature and humidity sensor 41, an intermediate transfer belt 14, and a patch pattern;

FIG. 3 is a flowchart for explaining a patch printing operation of the image forming apparatus 1, i.e., a preparation step in a print sheet creation method;

FIG. 4 is a conceptual diagram for explaining an excessive toner amount in a low-humidity environment;

FIG. 5 is a conceptual diagram for explaining a deficient toner amount in a high-humidity environment;

FIG. 6 is a conceptual diagram showing a relationship between absolute humidity (%) in an environment and a dither pattern density (%) for acquiring transparent binder toner (T) having a desired layer thickness;

FIG. 7 is a flowchart for explaining a printing operation of the image forming apparatus 1, i.e., the main step in the print sheet creation method;

FIG. 8A is a conceptual diagram showing a state where toner layers have been laminated in a laminated film transferred to a transfer sheet; and

FIG. 8B is a conceptual diagram showing a state where toner layers have been laminated in a print sheet.

### DETAILED DESCRIPTION OF THE PREFERRED EMBODIMENT

An embodiment of the present invention will hereinafter be described with reference to the drawings.

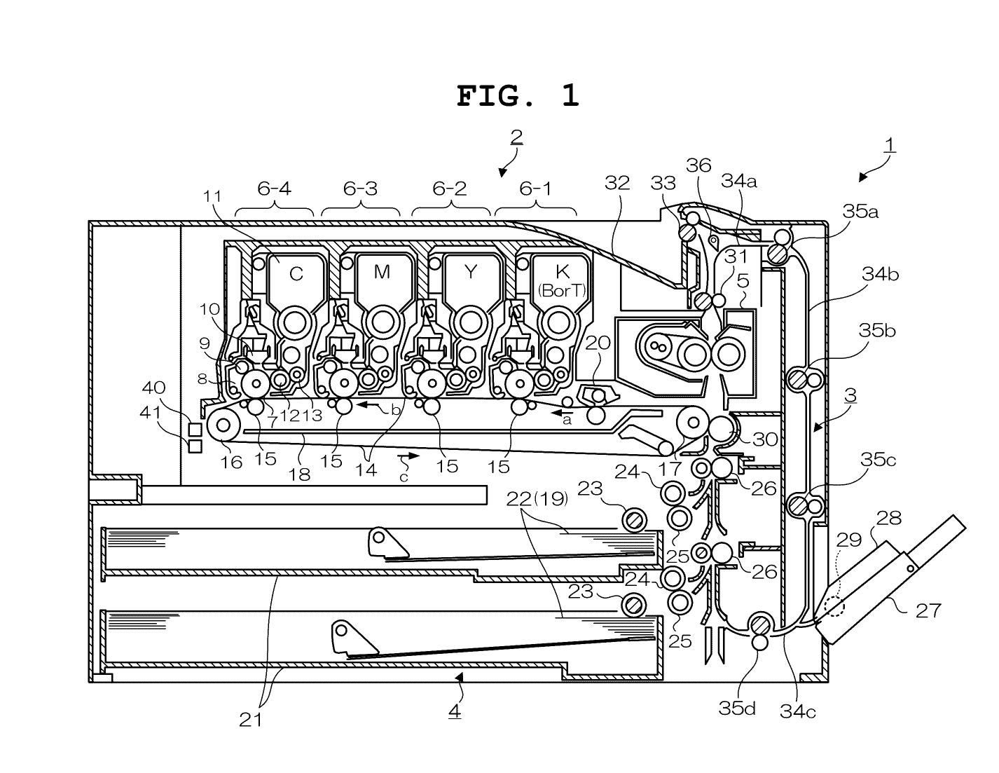

FIG. 1 is a cross-sectional view showing the internal structure of an image forming apparatus 1 according to an embodiment of the present invention. In FIG. 1, the image forming apparatus 1 according to the present embodiment is an electrophotographic image forming apparatus, and has adopted a method for transferring toner images to an intermediate transfer belt 14 serving as a first transfer target medium and secondarily transferring the toner images to a sheet (second transfer target medium) vertically conveyed to a secondary transfer section via the intermediate transfer belt 14.

The image forming apparatus 1 includes an image forming section 2, a two-sided printing conveyance section 3, a sheet feeding section 4, and a fixing section 5. The image forming section 2 has a structure where four image forming units (developing devices) 6 (6-1, 6-2, 6-3, and 6-4) are provided side by side in multiple stages. The image forming unit 6-1 on the uppermost flow side forms a monochrome image in black (K). The three image forming units 6-2, 6-3, and 6-4 subsequent to the image forming unit 6-1 respectively form monochrome images with color toner in yellow (Y), magenta (M), and cyan (C) serving as the subtractive primary colors. The toner images in the four colors are overlaid on a sheet to form a full-color image.

The image forming units 6-1 to 6-4 respectively have the same structures except for the color and the type of toner contained in a toner cartridge. Therefore, their structures will be described below using the structure of the image forming unit 6-4 as an example.

The image forming unit 6 has a photosensitive drum 7 in its lowermost portion. The peripheral surface of this photosensitive drum 7, for example, is formed of an organic photoconductive material. A cleaner 8, a charging roller 9, an optical writing head 10, and a developing roller 12 in a developing device 11 are arranged to come in contact with or around the peripheral surface of the photosensitive drum 7.

The developing device 11 has in its upper portion a toner container containing the toner of one of cyan (C), magenta (M), yellow (Y), and black (K), as indicated by C, M, Y, and K in FIG. 1, or transparent binder toner (T) or white binder toner (B), and has in its intermediate portion a toner replenishing mechanism oriented downward. The transparent binder toner (T) and the white binder toner (B), i.e., achromatic binder toner have the same composition (are of the same type). The transparent binder toner (T) is used when an image is bonded to a transfer target medium such as a T-shirt such that its ground color can be viewed, and the white binder toner (B) is used only when the colors of an image bonded to a transfer target medium such that its ground color cannot be viewed are desired to be shown. Note that, although a case is described below in which the transparent binder toner (T) is used in the first pass and the white binder toner (B) is used in the second pass, the same binder toner may be used in the first pass and the second pass, or the white binder toner (B) and the transparent binder toner (T) may be respectively used in the first pass and the second pass. Also, the transparent binder toner (T) and the white binder toner (B) may be collectively referred to as “achromatic binder toner” or “achromatic toner”.

The developing device 11 includes the above-described developing roller 12 in a lateral opening in its lower portion, and has in its inner portion a toner agitating member, a toner supply roller 13 for supplying toner to the developing roller 12, a doctor blade for regulating a toner layer on the developing roller 12 to a predetermined layer thickness, and the like. The optical writing head 10 on the apparatus body side is arranged near the upper surface of the photosensitive drum 7 between the charging roller 9 and the developing device 11.

Also, the intermediate transfer belt 14 is arranged near the lower surface of the photosensitive drum 7. A primary transfer roller 15 is pressed toward the lower surface of the photosensitive drum 7 with this intermediate transfer belt 14 interposed therebetween.

The intermediate transfer belt 14 is an endless-shaped transfer belt constituted by a conductive sheet-like member made of resin containing conductive carbon or an ion conductive material and extending in a flat loop shape substantially from the left end to the right end in FIG. 1 at a substantially center portion of the apparatus body. This intermediate transfer belt 14 is stretched between a driving roller 16 and a driven roller 17, and cyclically driven in the counterclockwise direction in FIG. 1 by the driving roller 16 to cyclically move in the counterclockwise direction indicated by arrows a, b, and c in FIG. 1. A belt cleaner 20 is arranged to come in contact with the front surface of the intermediate transfer belt 14. This belt cleaner 20 removes waste toner from the top of the intermediate transfer belt 14.

The photosensitive drum 7 rotates in the clockwise direction in FIG. 1. First, the peripheral surface of the photosensitive drum 7 is initialized by being equally charged by application of electric charge from the charging roller 9. Then, an electrostatic latent image is formed on the peripheral surface of the photosensitive drum 7 by optical writing from the optical writing head 10 based on printing information.

This electrostatic latent image is changed (developed) to a toner image using the toner contained in the developing device 11 by development processing using the developing roller 12. The toner image, which has been developed on the peripheral surface of the photosensitive drum 7, is directly transferred (primarily transferred) to the belt surface of the intermediate transfer belt 14 by the primary transfer roller 15 along with the rotation of the photosensitive drum 7. The intermediate transfer belt 14 conveys the toner image, which has been directly transferred (primarily transferred) to the belt surface, to a transfer position for a sheet 22 so as to further transfer (secondarily transfer) the toner image to the sheet 22.

A belt position control mechanism 18 in FIG. 1 includes primary transfer rollers 15, each of which is constituted by a conductive foamed sponge which is pressed against the lower peripheral surface of the photosensitive drum 7 with the intermediate transfer belt 14 interposed therebetween. This belt position control mechanism 18 rotationally moves the three primary transfer rollers 15 respectively corresponding to the three image forming units 6-4, 6-3, and 6-2 in cyan (C), magenta (M), and yellow (Y) in the same period with hook-type support shafts as their centers. Also, the belt position control mechanism 18 rotationally moves one primary transfer roller 15 corresponding to the image forming unit 6-1 in black (K) in a rotational movement period different from the period of the three primary transfer rollers 15 so that the intermediate transfer belt 14 comes in contact with or separates from the photosensitive drum 7.

More specifically, the belt position control mechanism 18 switches the position of the intermediate transfer belt 14 to a position for a full-color mode (all the four primary transfer rollers 15 come in contact with the intermediate transfer belt 14), a position for a monochrome mode (only the primary transfer roller 15 corresponding to the image forming unit 6-1 comes in contact with the intermediate transfer belt 14), and a position for a non-transfer mode (all the four primary transfer rollers separate from the intermediate transfer belt 14). Also, even when only the transparent binder toner (T) or the white binder toner (B) is primarily transferred in the creation of a thermal transfer print sheet, only the primary transfer roller 15 corresponding to the image forming unit 6-1 also comes in contact with the intermediate transfer belt 14, as in the above-described monochrome mode.

The sheet feeding section 4 includes two sheet cassettes 21 arranged in two upper and lower stages, and a large number of cut sheets 22 are stored in one or both of the sheet cassettes 21 in the sheet feeding section 4. Note that, in the case where a thermal transfer print sheet is created, a transfer sheet (or release sheet) 19 is used as a second transfer target medium in place of the sheet 22. A paper extraction roller 23, a feed roller 24, a separation roller 25, and a standby conveyance roller pair 26 are arranged near each of sheet feed ports (on the right side in FIG. 1) of the two sheet cassettes 21.

The sheets 22 are conveyed from the sheet cassette 21 one by one by the rotation of the paper extraction roller 23, and are fed to the standby conveyance roller pair 26 via the feed roller 24 and the separation roller 25. Alternatively, when the sheet 22 has an unusual thickness or size, the sheet 22 (or the transfer sheet 19) is fed to the standby conveyance roller pair 26 via a sheet feeding roller 29 from above an MPF (Multi Paper Feeder) tray 28 mounted on an opened mounting section 27.

A secondary transfer roller 30 in FIG. 1, which comes in pressure contact with the driven roller 17 with the intermediate transfer belt 14 interposed therebetween, is arranged in the paper conveyance direction (in the vertically upward direction in FIG. 1) of the standby conveyance roller pair 26. The intermediate transfer belt 14, the driven roller 17, and the secondary transfer roller 30 form a secondary transfer section for the sheet 22 (or transfer sheet 19).

The fixing section 5 including a belt-type thermal fixing unit is arranged on the lower flow side (on the upper side in FIG. 1) of this secondary transfer section. A conveyance roller pair 31 which conveys the sheet 22 (or the transfer sheet 19) after fixing from the fixing section 5, and a paper ejection roller pair 33 which ejects the conveyed sheet 22 to a paper ejection tray 32 formed on the upper surface of the apparatus are arranged on the even lower flow side of the fixing section 5.

The two-sided printing conveyance unit 3 includes a return path (a corridor loop pass) branched in the right lateral direction in FIG. 1 from a conveyance path in an intermediate portion between the conveyance roller pair 31 and the paper ejection roller pair 33. This return path includes a start return path 34a, an intermediate return path 34b bent downward, an end return path 34c bent in the left lateral direction for finally reversing a returned sheet, and four return roller pairs 35a, 35b, 35c, and 35d arranged halfway in the return paths. An outlet of the end return path 34c connects to a conveyance path directed toward the standby conveyance roller pair 26 corresponding to the sheet cassette 21 in a lower portion of the sheet feeding section 4.

Also, the two-sided printing conveyance unit 3 is used to not only perform two-sided printing but also perform multiple printing on the respective same surfaces of the sheets 22 (or the transfer sheets 19). In the present embodiment, the color toner in cyan (C), magenta (M), and yellow (Y) and the transparent binder toner (T) are transferred and fixed in the first pass, and then the white binder toner (B) is transferred and fixed in the second pass after the transfer sheet 19 being reset, as described above. The transfer sheet 19 may be manually reset in the sheet cassette 21 or the MFP tray 28 by a user, or may be automatically reset using the two-sided printing conveyance unit 3.

In the structure where the transfer sheet 19 is automatically reset, the transfer sheet 19 to which the color toner in cyan (C), magenta (M), and yellow (Y) and the transparent binder toner (T) have been transferred and fixed is first returned to the secondary transfer section (the driven roller 17 and the secondary transfer roller 30) via the return path in the two-sided printing conveyance unit 3. Accordingly, a route change flapper 36 is arranged near an inlet of the return path branched in the right lateral direction in FIG. 1 from the conveyance path in the intermediate portion between the conveyance roller pair 31 and the paper ejection roller pair 33. The route change flapper 36 is driven leftward or rightward in FIG. 1 near the inlet of the return path so as to sort the transfer sheets 19 conveyed from the fixing section 5 depending on whether the transfer sheet 19 is directly ejected, is conveyed in a paper ejection direction toward the paper ejection tray 32 to change a print surface, or is fed into the return path to repeatedly perform printing.

Also, on the lower flow side of the image forming unit 6-4 and near the intermediate transfer belt 14, a density sensor is arranged. This density sensor 40 is provided opposing the front surface of the intermediate transfer belt 14, and measures the density of a patch pattern (a density detecting pattern with the transparent binder toner (T)) formed on the outer peripheral surface of the intermediate transfer belt 14 (hereinafter referred to as “patch density”) at predetermined time intervals. Also, a temperature and humidity sensor 41 is similarly arranged on the lower flow side of the image forming unit 6-4 and near the intermediate transfer belt 14. This temperature and humidity sensor 41 measures temperature and humidity inside the image forming apparatus 1 at predetermined time intervals.

In the present embodiment, when chromatic toner is transferred and fixed in the first pass in the creation of a thermal transfer print sheet, the transparent binder toner (T) is also transferred and fixed to thinly cover the chromatic toner. When a transparent toner layer is laminated on a chromatic toner layer as described above, a stronger bonding force can be ensured by the transparent toner layer being welded onto the chromatic toner layer.

Also, the white binder toner (B) is relatively thickly laminated on the above-described transparent binder toner (T) in the second pass. The transparent binder toner (T) and the white binder toner (B) have the same composition (are of the same toner type), and therefore are welded to each other with a more reliable bonding force. There are also an effect of protecting a color toner image surface by thinly covering the chromatic toner with the transparent binder toner (T) and an effect of improving a bonding force by smoothing a surface to which the white binder toner (B) is transferred.

However, the transparent binder toner (T) forming a protective layer has a property that its toner transfer ratio becomes lower as the humidity becomes higher. In the present embodiment, as environment humidity increases, a latent image formed on the photosensitive drum 7 is changed to an image having an increased dither pattern density (the density of a dither pattern) with respect to the original image. That is, the image forming apparatus 1 controls the frequency of adjustment and the degree of adjustment of a density (a dither pattern density) in the transparent binder toner (T) based on results of measurement thereof (patch density, temperature, and humidity).

Note that transfer and fixing processing is performed by replacing a toner cartridge in the image forming unit 6-1 with a toner cartridge containing the white binder toner (B) in the second pass. Strictly speaking, the white binder toner (B) may be replaced with toner in any one of the image forming units 6-1 to 6-4 because it is not used simultaneously with the other toner. In the descriptions below, the toner cartridge in the image forming unit 6-1 will be described based on the premise that it is replaced with the toner cartridge containing the white binder toner (B).

In the final step, as a thermal transfer print sheet, the chromatic toner (color toner) in yellow (Y), magenta (M), cyan (C), or the like, the transparent binder toner (T), and the white binder toner (B) are laminated on the transfer sheet 19 in ascending order of layers.

Note that the above-described image forming apparatus 1 includes a CPU (Central Processing Unit) not shown, and controls the operation of each of the above-described sections by executing a predetermined program so as to actualize a predetermined function.

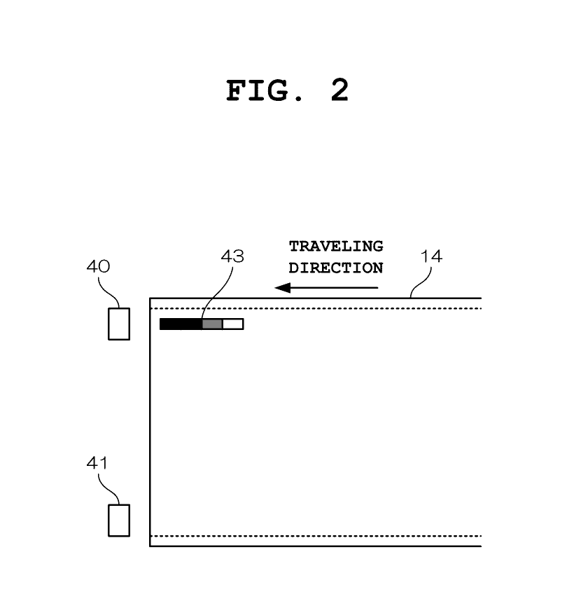

FIG. 2 is a conceptual diagram showing a positional relationship between the density sensor 40, the temperature and humidity sensor 41, and the intermediate transfer belt 14 in the image forming apparatus 1 according to the present embodiment and a patch pattern 43. The patch pattern 43 using the binder toner (B) is formed at predetermined time intervals on the outer peripheral surface of the intermediate transfer belt 14. Although the patch pattern 43 is basically formed at predetermined time intervals (e.g., every three hours, every six hours, or the like) or immediately before the start of a print job, the present invention is not limited thereto. For example, the patch pattern 43 is formed at timing according to an environment change based on temperature and humidity measured by the above-described temperature and humidity sensor 41. The above-described environment change corresponds to a case where a change in absolute humidity derived based on temperature and humidity measured by the above-described temperature and humidity sensor 41 is equal to or more than a predetermined threshold value, a case where a difference between absolute humidity and the previous absolute humidity is equal to or more than a predetermined threshold value, or a case where the present environment is expected to change to a low-humidity environment (e.g., absolute humidity is less than 20%) or a high-humidity environment (e.g., absolute humidity is 60% or more) after the elapse of several hours from the start of the temporal change of absolute humidity.

The image forming apparatus 1 derives, when the patch pattern 43 is formed, a dither pattern density on the photosensitive drum 7 in the transparent binder toner (T) such that the amount of the transparent binder toner (T) becomes an appropriate toner amount based on the patch density and the absolute humidity at that time. More specifically, the image forming apparatus 1 derives, when the environment is changed to the low-humidity environment or the high-humidity environment or when the environment is expected to change, a dither pattern density for a latent image on the photosensitive drum 7 in the transparent binder toner (T) such that the amount of the transparent binder toner (T) becomes an appropriate toner amount based on the patch density and the absolute humidity at that time.

For example, when the image forming apparatus 1 is in a low-humidity environment (e.g., absolute humidity is less than 20%) or is expected to be in a low-humidity environment several hours later, a dither pattern density for the transparent binder toner (T) is reduced based on the patch density and the absolute humidity at that time. That is, the transparent binder toner (T) tends to be thicker as the humidity becomes lower, and therefore the dither pattern density for the transparent binder toner (T) is adjusted to be reduced.

On the other hand, when the image forming apparatus 1 is in a high-humidity environment (e.g., absolute humidity is 60% or more) or is expected to be in a high-humidity environment several hours later, a dither pattern density for the transparent binder toner (T) is increased based on the patch density and the absolute humidity at that time. That is, the transparent binder toner (T) tends to be thinner as the humidity becomes higher, and therefore the dither pattern density for the transparent binder toner (T) is adjusted to be increased.

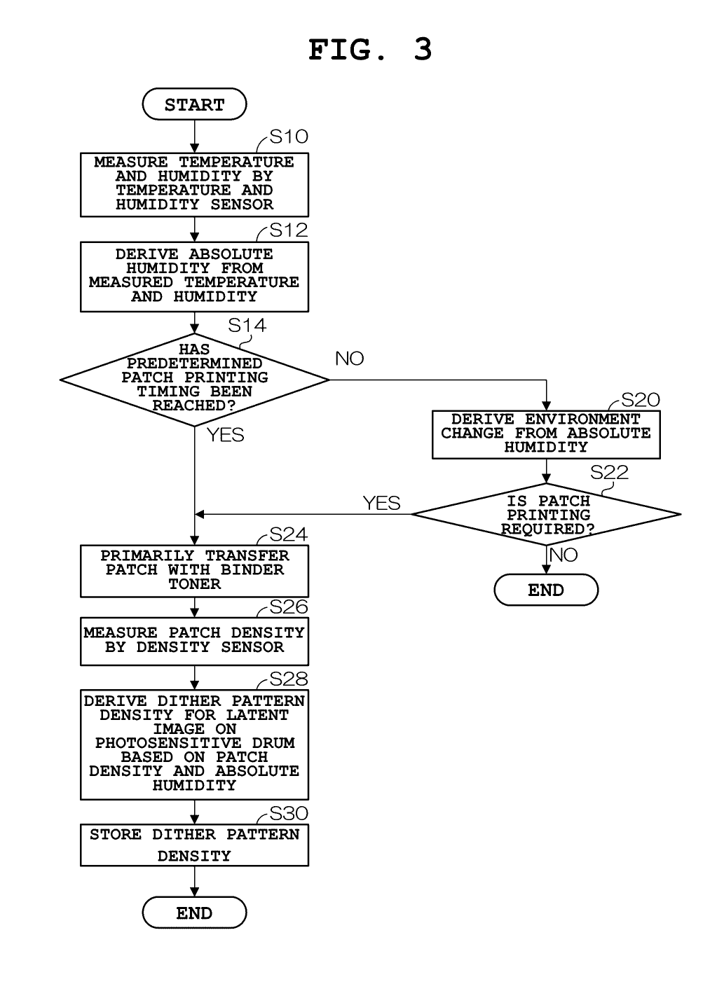

FIG. 3 is a flowchart for explaining an operation (patch printing) of the image forming apparatus 1 according to the present embodiment, i.e., a preparation step of a print sheet creation method. Note that the flowchart is executed at time intervals (e.g., intervals of several minutes or several ten minutes) shorter than predetermined patch printing timing (every three hours, every six hours, or immediately before the start of a print job).

First, the image forming apparatus 1 measures temperature and humidity inside the apparatus by the temperature and humidity sensor 41 (Step S10), and derives absolute humidity from the measured temperature and humidity (Step S12).

Then, the image forming apparatus 1 judges whether predetermined patch printing timing has been reached (Step S14). The predetermined patch printing timing described herein corresponds to predetermined time intervals (e.g., every three hours, every six hours, etc.) or the time immediately before the start of a print job, as described above.

When judged that the predetermined patch printing timing has been reached (YES at Step S14), the image forming apparatus 1 primarily transfers a patch to the outer peripheral surface of the intermediate transfer belt 14 with the transparent binder toner (T) at a currently-set dither pattern density (Step S24), and causes the density sensor 40 to measure the patch density (Step S26).

Then, the image forming apparatus 1 derives a dither pattern destiny for a latent image on the photosensitive drum 7 in the transparent binder toner (T) based on the patch density and the absolute humidity (Step S28), and stores the dither pattern density (Step S30).

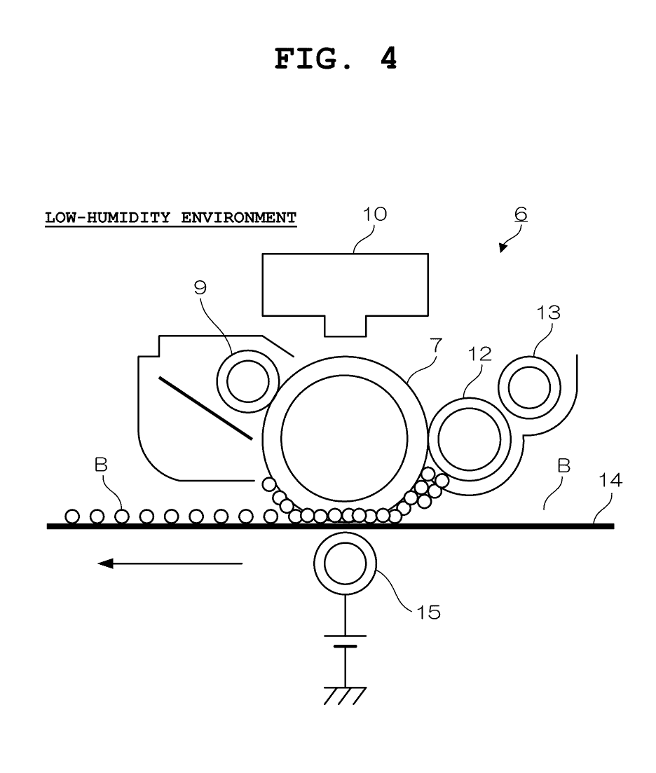

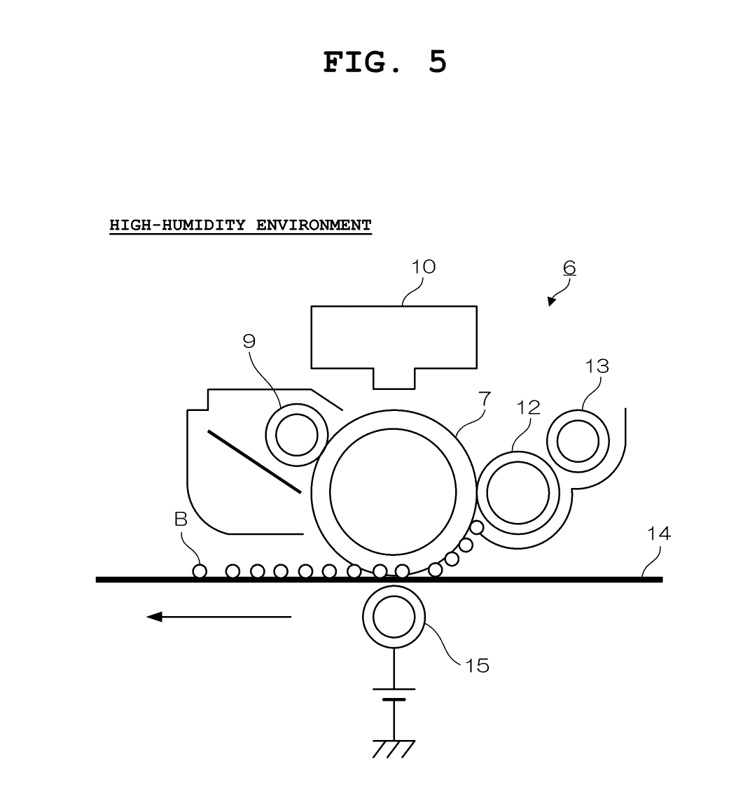

FIG. 4 is a conceptual diagram for explaining an excessive toner amount in a low-humidity environment. FIG. 5 is a conceptual diagram for explaining a deficient toner amount in a high-humidity environment. Note that sections corresponding to those shown in FIG. 1 are provided with the same reference numerals, and therefore descriptions thereof are not omitted. As shown in FIG. 4, the toner transfer ratio of the transparent binder toner (T) to the photosensitive drum 7 becomes high in a low-humidity environment, whereby toner in an amount exceeding an estimated amount is developed on the photosensitive drum 7. In this case, a dither pattern density for a latent image on the photosensitive drum 7 in the transparent binder toner (T) may be reduced so as to ensure a desired amount of adhesion. The dither pattern density at this time is used as a reference.

On the other hand, in a high-humidity environment, the transparent binder toner (T) absorbs a large amount of humidity, as shown in FIG. 5. Therefore, the charging characteristic is reduced, whereby the transfer ratio of electrostatic toner in the case of development on the photosensitive drum 7 and primary transfer to the intermediate transfer belt 14 becomes low. As a result, the amount of adhesion is reduced (toner density is reduced). Therefore, in a high-humidity environment, a dither pattern density for a latent image on the photosensitive drum 7 in the transparent binder toner (T) needs to be increased.

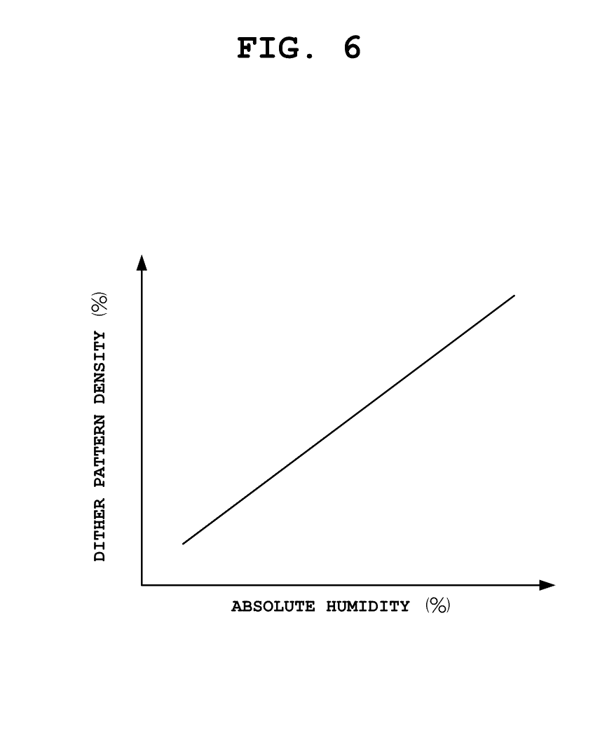

FIG. 6 is a conceptual diagram showing a relationship between absolute humidity (0) in an environment and a dither pattern density (t) for acquiring transparent binder toner (T) having a desired layer thickness. As shown in FIG. 6, a dither pattern density needs to be increased as absolute humidity in an environment increases. Accordingly, in the present embodiment, since a toner transfer ratio becomes lower as humidity becomes higher, control is performed to increase a dither pattern density for the transparent binder toner (T) forming a protective layer.

At Step S14, when judged that the predetermined patch printing timing has not been reached (NO at Step S14), the image forming apparatus 1 derives an environment change from the absolute humidity (Step S20). The environment change described herein includes a case where the current environment is clearly a high-humidity environment (e.g., the absolute humidity is 60 t or more), a case where a change of the absolute humidity from the previous measurement time is not less than a predetermined threshold value, and a case where the current environment is expected to become a high-humidity environment several hours later, based on the change history of the absolute humidity.

Then, the image forming apparatus 1 judges whether patch printing (density correction) is required because of the occurrence of the above-described environment change (Step S22). When judged that patch printing (density correction) is required because of the occurrence of the above-described environment change (YES at Step S22), the image forming apparatus 1 executes the above-described Step S24 and the following steps.

That is, the image forming apparatus 1 primarily transfers a patch with the transparent binder toner (T) (Step S24), causes the density sensor 40 to measure the patch density (Step S26), derives a dither pattern density for a latent image on the photosensitive drum 7 in the transparent binder toner (T) based on the patch density and absolute humidity (Step S28), and stores the dither pattern density (Step S30).

As described above, in the present embodiment, in addition to setting a dither pattern density for the transparent binder toner (T) based on respective measurement results of the density sensor 40 and the temperature and humidity sensor 41 at predetermined patch printing timing, the image forming apparatus 1 primarily transfers a patch and causes the density sensor 40 to measure the patch density when it judges that the environment has changed at timing other than the predetermined patch printing timing, and derives a dither pattern density for the transparent binder toner (T) based on humidity at that time point. That is, as the humidity increases, the dither pattern density for the transparent binder toner (T) is increased.

As a result, even the transparent binder toner (T) which is easily affected by environment can be deposited on a print target medium at a more appropriate density (in a desired amount).

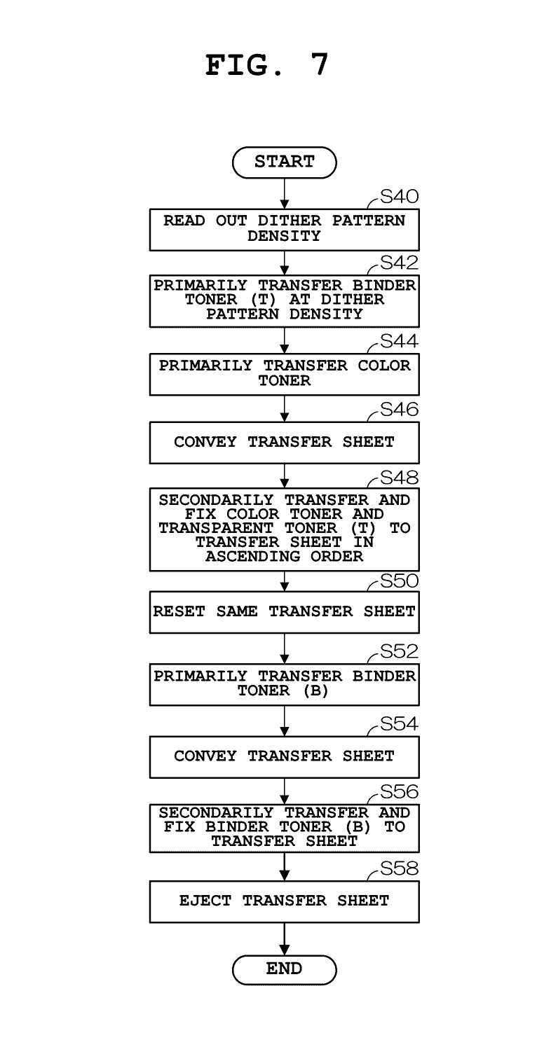

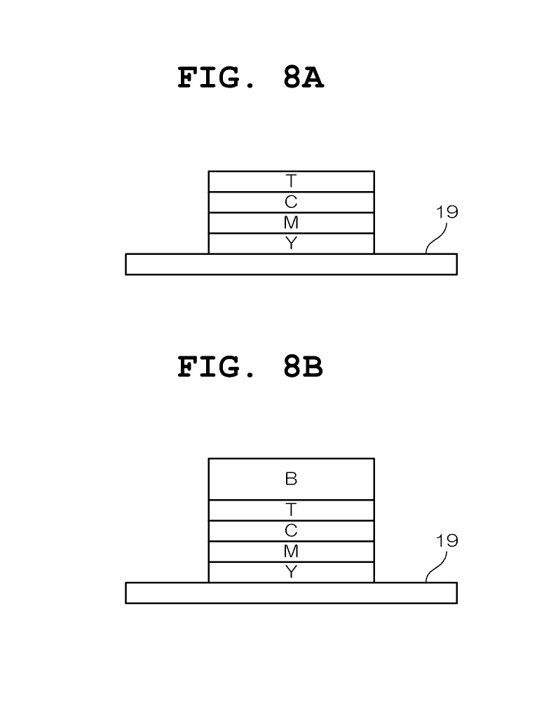

FIG. 7 is a flowchart for explaining an operation (printing operation) of the image forming apparatus 1 according to the present embodiment, i.e., the main step in the print sheet creation method. FIG. 8 is a conceptual diagram showing a state where toner has been laminated (a cross section of a laminated film) on a transfer sheet in a thermal transfer print sheet created by the image forming apparatus 1 according to the present embodiment. This flowchart is executed when a printing request is made from a host computer, an operation panel, or the like.

The image forming apparatus 1 reads out a dither pattern density stored in a memory or the like when a printing request is made (Step S40), primarily transfers an image using the transparent binder toner (T) to the intermediate transfer belt 14 at the dither pattern density (Step S42), and further primarily transfers an image using the color toner to the intermediate transfer belt 14 (Step S44).

More specifically, in the image forming unit 6-1, the photosensitive drum 7 is charged by the charging roller 9, a latent image is formed by the optical writing head 10 based on the above-described dither pattern density, this latent image is developed on the photosensitive drum 7 with the transparent binder toner (T), and a transparent toner layer including the binder toner (T) formed by the toner development is transferred onto the intermediate transfer belt 14 by the primary transfer roller 15. Similarly, in the image forming units 6-2 to 6-4, the photosensitive drum 7 is charged by the charging roller 9, a latent image is formed by the optical writing head 10, this latent image is developed on the photosensitive drum 7 with chromatic toner, and a chromatic toner layer including the chromatic toner formed by the development is transferred onto the transparent toner layer including the binder toner (T) on the intermediate transfer belt 14 by the primary transfer roller 15. That is, a laminated film including the transparent toner layer and the chromatic toner layer is formed on the intermediate transfer belt 14. In the laminated film at this point, the transparent toner layer is the lowermost layer.

Also, the image forming apparatus 1 conveys the transfer sheet 19 by the rotation of the paper extraction roller 23 from the sheet cassette 21, and feeds the conveyed transfer sheet 19 to the standby conveyance roller pair 26 via the feed roller 24 and the separation roller 25 so as to make the transfer sheet 19 stand by (Step S46). Then, the image forming apparatus 1 feeds the transfer sheet 19, which has been made to stand by at a position of the standby conveyance roller pair 26, into the secondary transfer section (the driven roller 17 and the secondary transfer roller 30) at timing at which the laminated film serving as a toner image formed on the intermediate transfer belt 14 reaches the secondary transfer section, secondarily transfers the laminated film (a color image and an image with the transparent binder toner (T)) to the transfer sheet 19 from the top of the intermediate transfer belt 14, and then causes the fixing section 5 to fix the laminated film (Step S48). The intermediate transfer belt 14 after the secondary transfer is cleaned by the belt cleaner 20, whereby the first pass of the process for creating a thermal transfer print sheet is ended.

Note that, in the laminated film, the transparent toner layer becomes the uppermost layer by the secondary transfer. More specifically, layers in yellow (Y), magenta (M), and cyan (C) are sequentially laminated in ascending order as a chromatic toner layer on the transfer sheet 19 as shown in FIG. 8A, and a transparent toner layer including the binder toner (T) is laminated thereon. Here, the transparent toner layer has been formed at a dither pattern density set in accordance with absolute humidity in the environment.

Then, the image forming apparatus 1 again sets, on the sheet cassette 21 or the MPF tray 28, the transfer sheet 19 to which the laminated film (the color image and the image with the transparent binder toner (T)) has been transferred and fixed (Step S50). Note that the user may manually reset the same transfer sheet 19, or may drive the route change flapper 36 in the above-described two-sided printing conveyance unit 3 so as to change the route toward the return path and automatically reset the transfer sheet 19. Here, the image forming apparatus 1 may prompt the user to perform a resetting operation of the transfer sheet 19 by displaying the reset of the transfer sheet 19 on an operation panel (not shown) or the like.

Also, the white binder toner (B) is mounted in this stage. Here, the image forming apparatus 1 may prompt the user to perform a toner replacement operation by displaying toner replacement on an operation panel (not shown) or the like.

Then, the image forming apparatus 1 primarily transfers a white toner layer including the white binder toner (B) to the intermediate transfer belt 14 (Step S52). More specifically, in the image forming unit 6-1, the photosensitive drum 7 is charged by the charging roller 9, a latent image is formed by the optical writing head 10 at a dither pattern density read out, this latent image is developed on the photosensitive drum 7 with the white binder toner (B), and the white toner layer including the white binder toner (B) formed by the toner development is transferred to the intermediate transfer belt 14 by the primary transfer roller 15.

Then, the image forming apparatus 1 feeds the transfer sheet 19, to which the laminated film (the color image or the like) has already been fixed, into the secondary transfer section (the driven roller 17 and the secondary transfer roller 30) at timing at which the white toner layer including the binder toner (B) transferred onto the intermediate transfer belt 14 reaches the secondary transfer section (Step S54), secondarily transfers the white toner layer from the intermediate transfer belt 14 to cover the laminated film in the transfer sheet 19, and then causes the fixing section 5 to fix the white toner layer (Step S56). The intermediate transfer belt 14 after the secondary transfer is cleaned by the belt cleaner 20 cleans, and the second pass of the process for creating a thermal transfer print sheet is ended.

The thermal transfer print sheet created as described above has a structure where layers in yellow (Y), magenta (M), and cyan (C) have been sequentially laminated in ascending order as a chromatic toner layer on the transfer sheet 19 as shown in FIG. 8B, and the transparent toner layer including the binder toner (T) and the white toner layer including the binder toner (B) have been sequentially laminated thereon as an achromatic toner layer.

Then, the image forming apparatus 1 ejects to the paper ejection tray 32 the transfer sheet 19 on which the color image and respective layers including the transparent binder toner (T) and the white binder toner (B) have been formed and which are conveyed from the fixing section 5 (Step S58).

When a surface of the created thermal transfer print sheet on which the white binder toner (B) layer has been formed is pressed against a final transfer target medium such as a T-shirt, and pressure and heat are applied from the side of the mediating transfer sheet 19, the image formed on the transfer sheet 19 can be transferred to the final transfer target medium, and this image can be removed from the transfer sheet 19. That is, the white binder toner (B) layer functions as an adhesive layer between the thermal transfer print sheet and the final transfer target medium.

According to the above-described embodiment, the fixing section can weld toner layers, that is, chromatic toner and transparent binder toner (T) with heat. Therefore, a bonding force therebetween can be ensured.

Also, according to the above-described embodiment, as humidity in an environment detected by the temperature and humidity sensor 41 increases, a dither pattern density for a latent image formed on the photosensitive drum 7 in the transparent binder toner (T) is increased. Thus, a desired amount of toner can be deposited even if its toner transfer ratio decreases as the humidity increases.

Moreover, according to the above-described embodiment, a chromatic toner layer and a transparent toner layer are formed as a laminated film on the transfer sheet 19, and a white toner layer serving as an adhesive agent layer is formed thereon. As a result of this configuration, when a white toner layer is to be formed, a ground having the same composition as that of the white toner layer has already been formed as a transparent toner layer. Therefore, a thermal transfer print sheet having a reliable bonding force can be created. Also, by being thinly covered with a transparent toner layer including binder toner (T), an image surface represented by a chromatic toner layer can be protected and a surface to which a white toner layer including binder toner (B) is transferred is smoothed, whereby the bonding force between the toner layers can be improved.

Furthermore, according to the above-described embodiment, the image forming apparatus 1 judges whether an environment change equal to or more than a predetermined threshold value has occurred based on humidity in the environment by the temperature and humidity sensor 41, and shortens intervals at which the formation of a density detection pattern and the density detection of the density detection pattern by the density sensor 40 are performed when an environment change equal to or more than the predetermined threshold value occurs. As a result of this configuration, environment changes can be easily dealt with.

Still further, according to the above-described embodiment, by a transfer target medium where toner has been secondarily transferred being conveyed again to the secondary transfer position by the route change flapper 36, the toner is secondarily transferred to the same transfer target medium more than once. As a result of this configuration, the transfer and the fixing of binder toner (B) in the second pass can be performed with a simple structure.

In the above-described embodiment, as humidity increases, a dither pattern density for the transparent binder toner (T) is increased. However, the present invention is not limited thereto. If there exists a humidity range where a change to be a problem does not occur in the layer thickness of the transparent binder toner (T), the dither pattern density need not be changed in the humidity range.

Also, in the above-described embodiment, the transparent binder toner (T) is used in the first pass, and replaced with the white binder toner (B) in the second pass. However, this replacement may be omitted by using the same binder toner in the first pass and the second pass.

Moreover, in the above-described embodiment, the temperature and humidity sensor 41 is arranged near the intermediate transfer belt 14 on the lower flow side of the image forming unit 6-4. However, the temperature and humidity sensor 41 may be arranged at another position. Particularly, the temperature and humidity sensor 41 may be arranged near the image forming unit 6-1 containing binder toner (B or T) which is easily affected by environmental change.

Furthermore, in the above-described embodiment, the density sensor 40 detects the density of a patch pattern on the intermediate transfer belt 14. However, the density sensor 40 may be arranged near the photosensitive drum 7 to detect the density of a patch pattern developed on the photosensitive drum 7.

Still further, in the above-described embodiment, the temperature and humidity sensor 41 is arranged outside the developing device 11 containing toner, and control is performed based on the tendency of the density of the toner to be developed in accordance with the characteristic of the toner with respect to temperature and humidity outside the developing device 11. However, the control may be performed taking into consideration a time difference until the temperature and the humidity outside the developing device 11 actually affect the toner in the developing device 11. Alternatively, the control may be performed by the temperature and humidity sensor 41 being arranged inside the developing device 11 and the temperature and the humidity of the actually contained toner being measured.

Yet still further, in the above-described embodiment, a contact mono-component developing device has been described as the developing device 11. However, as a matter of course, a magnetic brush two-component developing device may be used to perform the same operation.

While the present invention has been described with reference to the preferred embodiments, it is intended that the invention be not limited by any of the details of the description therein but includes all the embodiments which fall within the scope of the appended claims.

What is claimed is:

1. A print sheet creation method, comprising:
a first transfer step of forming a laminated film by transferring a first toner layer including achromatic toner and a second toner layer including chromatic toner and formed on the first toner layer to a first transfer target medium;
a second transfer step of transferring the laminated film formed in the first transfer step to a second transfer target medium from the first transfer target medium such that the first toner layer is an uppermost layer;
a first fixing step of fixing the laminated film transferred to the second transfer target medium in the second transfer step to the second transfer target medium; and
a third transfer step of transferring a third toner layer which includes achromatic toner and is thicker than the first toner layer to the laminated film fixed to the second transfer target medium in the first fixing step and having the first toner layer as the uppermost layer.

2. The print sheet creation method according to claim 1, wherein the first toner layer includes transparent binder toner and the third toner layer includes white binder toner.

3. The print sheet creation method according to claim 1, wherein the first toner layer and the third toner layer include transparent binder toner.

4. The print sheet creation method according to claim 1, wherein the first toner layer and the third toner layer include white binder toner.

5. The print sheet creation method according to claim 1, further comprising:
a second fixing step of fixing again the laminated film to which the third toner layer has been transferred in the third transfer step.

6. A print sheet creation method, comprising:
a first step of forming, on a predetermined sheet, an image acquired by laminating a first achromatic toner layer and a chromatic toner layer such that the first achromatic toner layer is an uppermost layer, by using electrophotography; and
a second step of forming a second achromatic toner layer on the sheet where the image has been formed in the first step such that the second achromatic toner layer covers the first achromatic toner layer and is thicker than the first achromatic toner layer, by using electrophotography.

7. The print sheet creation method according to claim 6, wherein the first achromatic toner layer includes transparent binder toner and the second achromatic toner layer includes white binder toner.

8. The print sheet creation method according to claim 6, wherein the first achromatic toner layer and the second achromatic toner layer include transparent binder toner.

9. The print sheet creation method according to claim 6, wherein the first achromatic toner layer and the second achromatic toner layer include white binder toner.

10. The print sheet creation method according to claim 6, wherein the first step includes forming the image as a chromatic toner layer including toner in cyan, magenta, or yellow.

11. A print sheet creation method, comprising:
a first step of forming an image covered with a protective layer on a predetermined sheet by using electrophotography; and
a second step of forming, on the sheet where the image covered with the protective layer has been formed, an adhesive layer including toner of same type as toner constituting the protective layer such that the adhesive layer covers the protective layer and is thicker than the protective layer, by using electrophotography.

12. The print sheet creation method according to claim 11, wherein the protective layer includes transparent binder toner, and the adhesive layer includes white binder toner.

13. The print sheet creation method according to claim 11, wherein the protective layer and the adhesive layer include transparent binder toner.

14. The print sheet creation method according to claim 11, wherein the protective layer and the adhesive layer include white binder toner.

15. The print sheet creation method according to claim 11, wherein the first step includes forming the image as a chromatic toner layer including toner in cyan, magenta, or yellow.
